(19) United States
(12) Patent Application Publication
(10) Pub. No.: US 2003/0002231 A1
(43) Pub. Date: Jan. 2, 2003

(54) Reduced sensitivity spin valve head for magnetic tape applications

(76) Inventor: Richard Henry Dee, Boulder, CO (US)

Correspondence Address: Wayne P. Bailey,, Storage Technology Corporation, One Storage Tek Drive, Louisville, CO, 80028-4309, US

(21) Appl. No.: 09/894,479

(22) Filed: Jun. 29, 2001

(51) Int. Cl. G11B 5/39

(52) U.S. Cl. 360/324.12; 360/314; 360/319

(57) ABSTRACT

Apparatus and methods for reducing the sensitivity of spin valve sensor read heads for magnetic tape applications are provided. The apparatus and methods compromise the large output gain derived from using state of the art spin valve sensors in order to reduce the flux capture and thus, the signal distortion in the spin valve sensor. In order to provide a reduced sensitivity spin valve sensor, one or more of the basic sensitivity of the spin valve, the flux carrying capability of the free layer, and the flux injection efficiency of the spin valve head structure are modified to reduce the flux capture by the sensing layer.

### RELATED APPLICATIONS

The present application is related to commonly assigned and copending U.S. patent application Ser. No. ______ (Attorney Docket No. 2001-019-TAP) entitled “APPARATUS AND METHOD OF MAKING A REDUCED SENSITIVITY SPIN VALVE SENSOR APPARATUS IN WHICH A BASIC MAGNETIC SENSITIVITY IS REDUCED,” U.S. patent application Ser. No. ______ (Attorney Docket No. 2001-020-TAP) entitled “APPARATUS AND METHOD OF MAKING A REDUCED SENSITIVITY SPIN VALVE SENSOR APPARATUS IN WHICH A FLUX CARRYING CAPACITY IS INCREASED,” and U.S. patent application Ser. No. ______ (Attorney Docket No. 2001-021-TAP) entitled “APPARATUS AND METHOD OF MAKING A REDUCED SENSITIVITY SPIN VALVE SENSOR APPARATUS IN WHICH A FLUX INJECTION EFFICIENCY IS REDUCED,” all of which are filed on even date herewith and are hereby incorporated by reference.

### BACKGROUND OF THE INVENTION

1. Technical Field

The present invention is directed to a reduced sensitivity spin valve head for magnetic tape applications.

2. Description of Related Art

The requirement of high density magnetic storage of data on hard disk drives has been increasing steadily for the past several years. Hard disk drives include magnetic heads for reading and writing data to the hard disk. The magnetic heads include write coils and sensors for reading data from the disks.

Development of magnetoresistive (MR) sensors (also referred to as heads) for disk drives in the early 1990's allowed disk drive products to maximize storage capacity with a minimum number of components (heads and disks). Fewer components result in lower storage costs, higher reliability, and lower power requirements for the hard disk drives.

MR sensors are used for the read element of a read/write head on a high-density magnetic disk. MR sensors read magnetically encoded information from the magnetic medium of the disk by detecting magnetic flux stored in the magnetic medium of the disk. As storage capacity of disk drives has increased, the storage bit has become smaller and its magnetic field has correspondingly become weaker. MR heads are more sensitive to weaker magnetic fields than are the inductive read coils used in earlier disk drives. Thus, there has been a move away from inductive read coils to MR sensors for use in disk drives.

During operation of the hard disk drive, sense current is passed through the MR element of the sensor causing a voltage drop. The magnitude of the voltage drop is a function of the resistance of the MR element. Resistance of the MR element varies in the presence of a magnetic field. Therefore, as the magnitude of the magnetic field flux passing through the MR element varies, the voltage across the MR element also varies. Differences in the magnitude of the magnetic flux entering the MR sensor can be detected by monitoring the voltage across the MR element.

As discussed above, MR sensors are known to be useful in reading data with a sensitivity exceeding that of inductive or other thin film sensors. However, the development of Giant Magnetoresistive (GMR) sensors (also referred to as GMR head chips or Spin Valve sensors) has greatly increased the sensitivity and the ability to read densely packed data. Thus, although the storage density for MR disks is expected to eventually reach 5 gigabits per square inch of surface disk drive (Gbits/sq.in.), the storage density of GMR disks is expected to exceed 100 Gbits/sq.in.

While GMR sensors, also known as Spin Valve sensors, have increased the sensitivity of read heads of disk drives thereby allowing for advances in the recording density in magnetic disk recording technologies, it would be beneficial to be able to apply the spin valve sensors to other magnetic media, such as magnetic tape media. However, the differences in performance of recording on magnetic tape and recording on magnetic disk media prevent the simple application of spin valve sensors to magnetic tape media.

Information is written onto a magnetic tape by magnetizing tape regions. These magnetized tape regions produce a magnetic field, which can be detected and converted into an electrical signal by a read head.

Generally, a variety of different signal flux levels, i.e. levels of the magnetic field generated by the magnetic tape media, can be produce from various data patterns recorded on a magnetic tape. For example, low density patterns present a larger magnetic flux to the spin valve sensor leading to higher signal amplitude than high density patterns which have a lower level of magnetic flux. A spin valve head is typically designed and optimized to read the high density patterns in order to have significant amplitude for signal detection. However, the high input flux from a low density pattern can drive a spin valve sensor designed for high density operation into non-linear portions of the spin valve response curve. This leads to readback distortions and may even cause the spin valve sensor to magnetically saturate.

Write equalization, a method of breaking up the low density signal with high density pulses, is often employed to provide some equalization of the signal flux as detected by the spin valve sensor. Unfortunately, due to the increased complexity and cost of implementation, write equalization has not been universally applied in tape recording. Further, the problem of distortion when reading low density waveforms is accentuated in systems where downward read compatibility is required. In such situations the range of recording densities seen by the head can be extreme. Standard read head designs are not capable of producing a sufficient readback amplitude at the high recording densities without high readback distortion at the lower densities.

Thus, it would be beneficial to have a reduced sensitivity spin valve head for magnetic tape applications in which much of the benefits of standard spin valve sensors are maintained while compensating for excessive input flux that may overpower the spin valve sensor.

### SUMMARY OF THE INVENTION

The present invention provides a reduced sensitivity spin valve head for magnetic tape applications. The present invention compromises a portion of the large output gain derived from using state of the art spin valve sensors in order to reduce the flux capture and thus, the signal distortion in the spin valve sensor. In order to provide a reduced sensitivity spin valve sensor, one or more of the basic sensitivity of the spin valve, the flux carrying capability of a free layer, and a flux injection efficiency of the spin valve head structure are modified to reduce the flux capture by the sensing layer.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a data recording system in which the present invention may be implemented;

FIGS. 2A and 2B are exemplary block diagrams illustrating a spin valve sensor in a magnetic read/write head in accordance with embodiments of the present invention;

FIGS. 3 and 4 are exemplary diagrams of layer configurations that may comprise a spin valve sensor in accordance with the present invention;

FIG. 5A is an exemplary diagram illustrating the manner by which the pinned and free layers of a spin valve sensor operate in the presence of an applied field;

FIG. 5B is a diagram illustrating saturation of a spin valve sensor;

FIG. 6 is an exemplary diagram illustrating spin valve sensor saturation;

FIG. 7 is an exemplary diagram illustrating the effects of increasing the field required to saturate the spin valve sensor;

FIG. 8 is an exemplary block diagram illustrating one embodiment of the present invention in which permanent magnet stabilizing elements are used to stiffen the sensing layer;

FIGS. 9A and 9B are exemplary diagrams of two other embodiments in which an antiferromagnet or zero angle pinned ferromagnet layer is used to alter the magnetic sensitivity of a standard spin valve sensor;

FIG. 10A is a diagram illustrating a prior art dual spin valve using two pinned layers;

FIG. 10B is an exemplary diagram illustrating a dual spin valve using two free layers and two pin layers in accordance with the present invention; and

FIG. 11 is an exemplary diagram of spin valve sensor read head in which two spin valve sensors are utilized.

### DETAILED DESCRIPTION OF THE PREFERRED EMBODIMENT

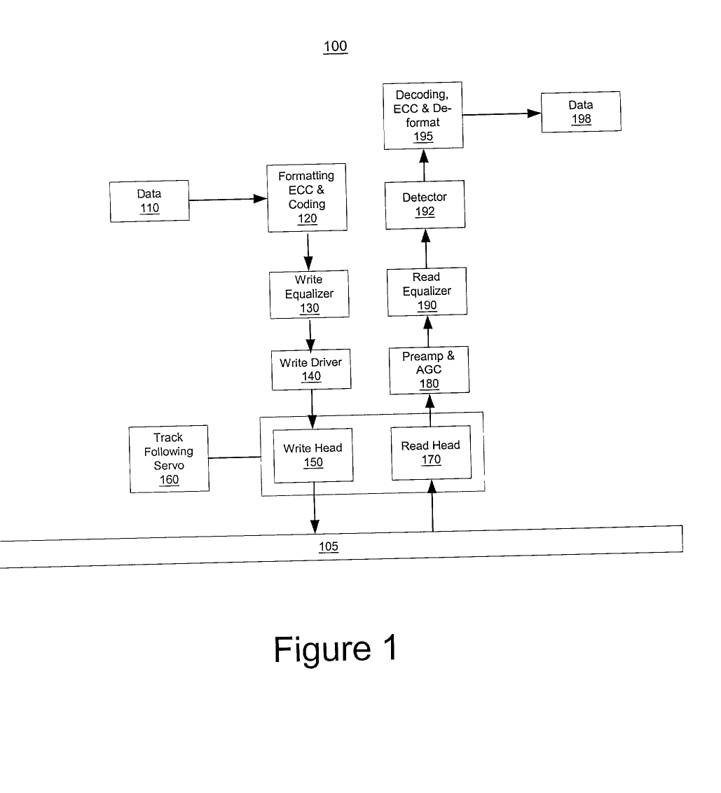

With reference now to the figures, and in particular with reference to FIG. 1, a block diagram of a data tape recording system in which the present invention may be implemented is illustrated. Data recording system 100 is an example of a tape recording system that can record data from a host computer onto magnetic tape. User data 110 enters the system to be written to magnetic tape media. The data is formatted and encoded 120, passed through a write equalizer circuit 130 (if necessary), and fed to the writing head 150 by means of a write driver 140 which supplies the electric current signals required for recording on the magnetic tape medium 105.

When reading the recorded data from the magnetic tape medium 105, the magnetic tape medium 105 is passed by a read head 170 in which the present invention may be implemented, as discussed hereafter. The read head 170 transforms the magnetic flux emanating from the magnetic tape medium into electric voltage signals by means of the magnetoresistive effect. These voltages are amplified 180 and amplitude equalized 190 before being passed into a detector 192 that interprets the signals as digital data. The data is un-encoded 195 and the user data 196 restored to the host computer.

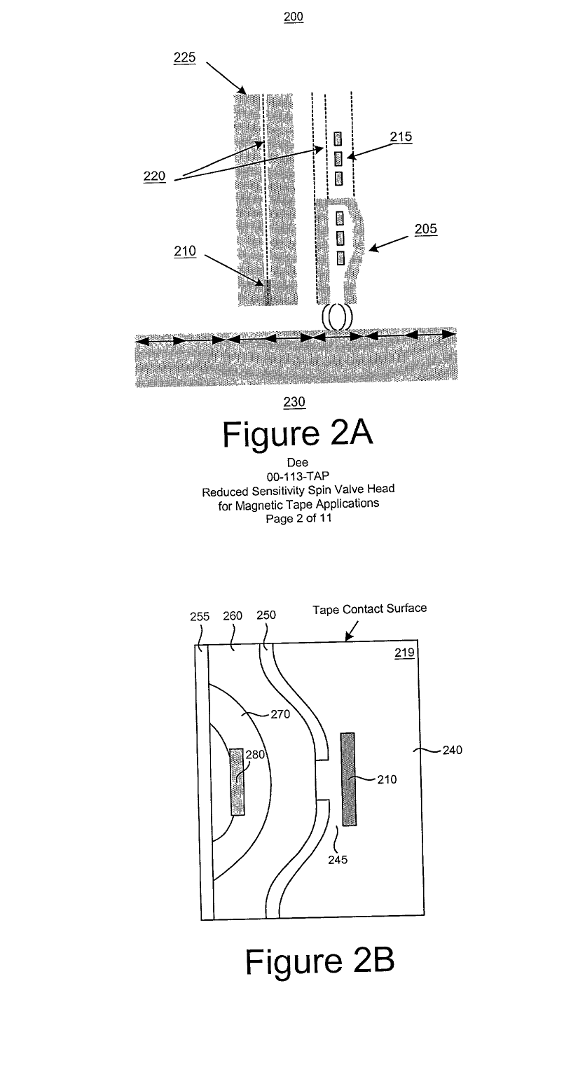

FIGS. 2A and 2B show cross sections of a magnetic head 200 having a giant magnetoresistive (GMR) sensor or spin valve sensor 210. As shown in FIG. 2A, the magnetic head 200 includes an adjacent write head yoke 205, a spin valve sensor 210, coils 215, layered dielectrics 220, and magnetic shields 225. The magnetic head 200 is positioned above but in contact with a magnetic tape media 230. A gap between the magnetic head 200 and the magnetic tape media 230 is shown in FIG. 2A for clarity only. The coils 215 generate a magnetic field for writing data to the magnetic tape media 230. The coils 215 are wrapped around yoke 205 which focuses the magnetic field created by the coils 215. The spin valve sensor 210 is used for reading data from the magnetic tape media 230. The layered dielectrics 220 are used as an insulator for insulating the spin valve sensor 210 from the magnetic shields 225. The magnetic shields 225 shield the spin valve sensor from upstream and downstream bits during the read operation.

FIG. 2B shows a magnified view of a yoke style spin valve read head. The read head 219 includes a magnetoresistive spin valve element 210, i.e. spin valve sensor 210, positioned between two layers of an overcoat insulating material 240 and 245. The magnetoresistive spin valve element 210 is in close proximity to a top flux guide 250. The top flux guide 250 is separated from a bottom flux guide 255 by a gap insulator 260, planars 270, and bias conductor 280.

When the magnetoresistive (MR) spin valve element 210 is formed, a magnetic field is typically applied in a direction parallel to the plane of the spin valve element 210. Thus, the MR spin valve element 210 exhibits a uniaxial anisotropy with an easy-axis of magnetization parallel to the direction of the applied field. As a magnetic tape media passes the spin valve read head, an external magnetic field is conducted by the top flux guide 250 and the bottom flux guide 255 to generate a magnetic field that is applied normal to the easy-axis of the MR spin valve sensing layer element 210. The gap insulator 260, planars 270 and bias conductor 280 aid in conducting the magnetic flux from the magnetic tape media so that it is applied normal to the easy axis of the MR spin valve sensing layer element 210.

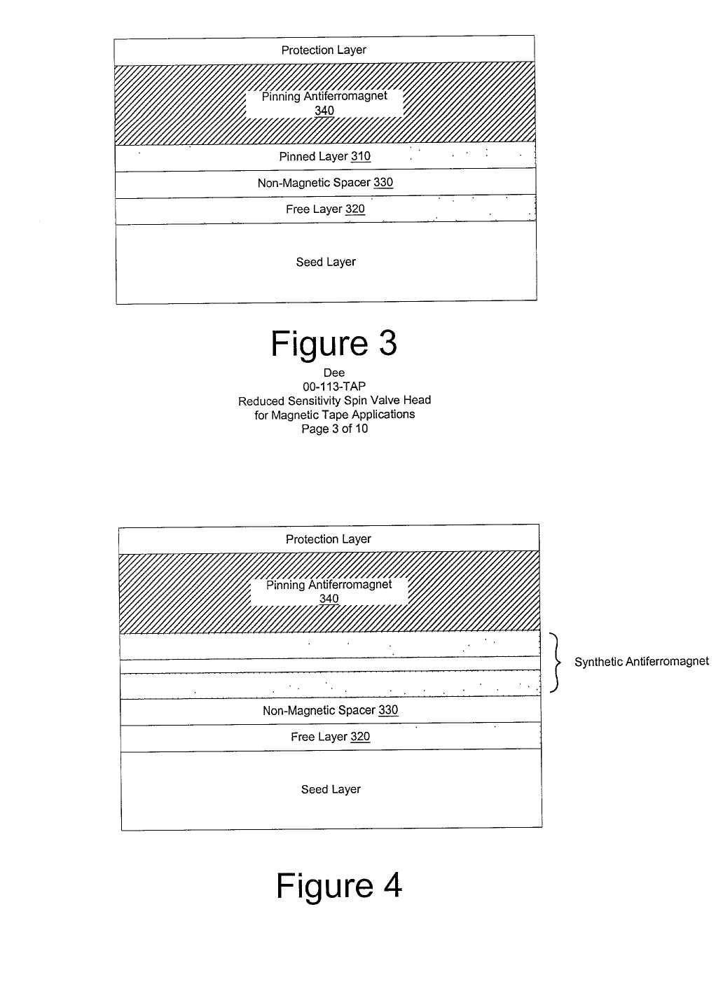

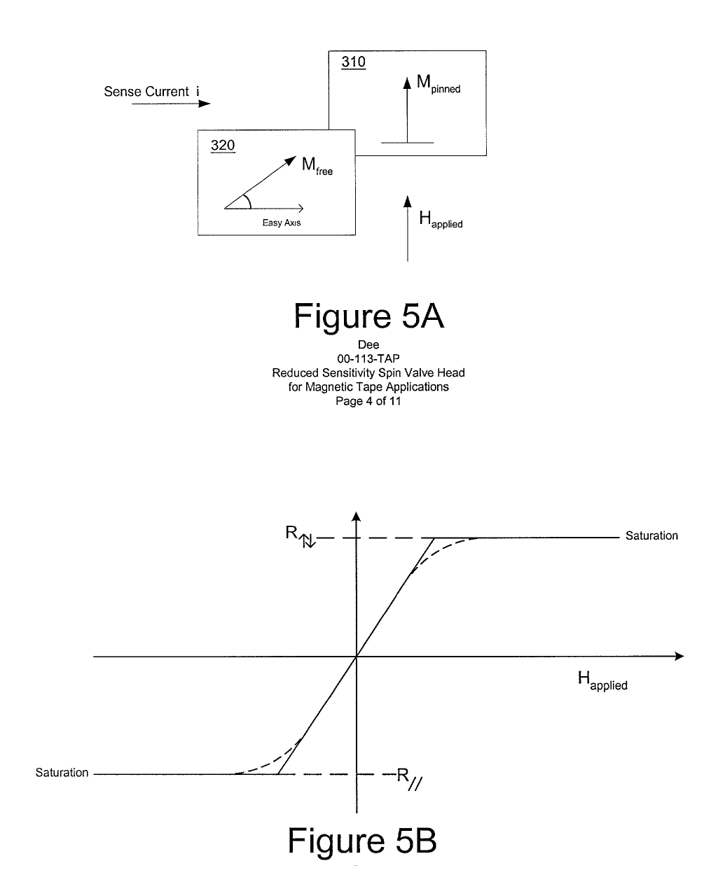

The spin valve sensor in these head structures is briefly described as follows. Referring to FIGS. 3 and 4, the spin valve is a layered structure based on two ferromagnetic layers 310 and 320 (for example, NiFe or CoFe) separated by a thin non-magnetic layer 330 (e.g., copper). One of the ferromagnetic layers 310 has its magnetization pinned, i.e. fixed, at 90 degrees with respect to the other ferromagnetic layer's 320 longitudinal oriented easy axis. This is called the pinned layer 310 and is held in place by the exchange field from an adjacent antiferromagnet 340 (such as NiO, PtMn or NiMn). The second ferromagnetic layer 320 has its magnetization free to rotate for sensing applied magnetic fields and is called the free or sensing layer.

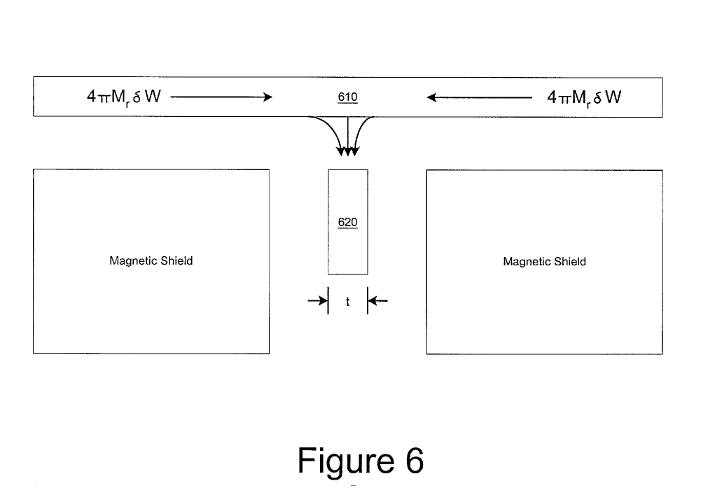

FIGS. 3 and 4 are two embodiments of spin valves with different types of antiferromagnet/ferromagent arrangements to achieve the same end. A diagram of the magnetic situation is shown in FIG. 5A. In response to an external magnetic field H_{applied} being applied normal to the easy axis of the spin valve element free layer, the magnetization direction of the free layer rotates away from the easy axis direction toward the direction of the applied field. This magnetization rotation causes the electrical resistance of the spin valve element to change. Based on changes in the resistance of the MR spin valve element and thus, the voltage output seen in the presence of a sense current i, the data recording on the magnetic tape can be read.

Saturation of the sensing layer of the spin valve occurs when the magnetization cannot rotate further. Once the layers magnetization is fully parallel to the applied field, the resistance ceases to change with further increases in applied magnetic field. FIG. 5B demonstrates this relationship between the applied field and the change in resistance.

The present invention provides apparatus for reducing the sensitivity of a conventional spin valve sensor so that it may be used with magnetic tape media without causing saturation of the spin valve sensor. In this way, the induced signal distortion that would occur if a conventional spin valve sensor were used with magnetic tape media is avoided.

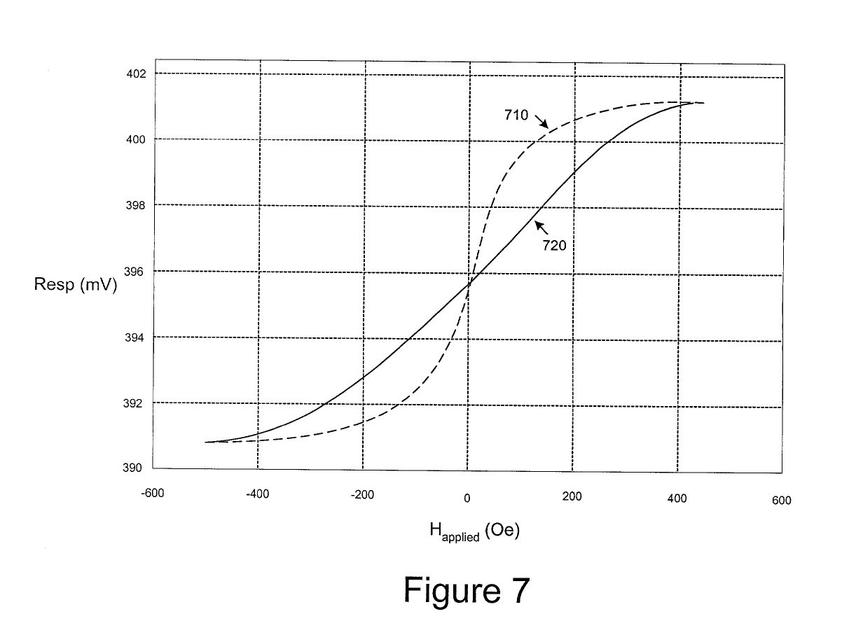

FIG. 6 is an exemplary diagram illustrating the components used to calculate spin valve saturation. As shown in FIG. 6, the input flux from magnetic tape media 610 that is sensed by the spin valve sensor 620 is represented as 4πMᵣδW where Mᵣ is the remnant magnetic moment, i.e. the magnetic moment of the magnetized region on the tape once the magnetizing field has been removed after the writing process, δ is the thickness of the magnetic tape media, W is the width of the magnetic tape media, and 4π is a constant. Since the flux that is sensed by the spin valve sensor 620 is obtained from both opposing regions of magnetized tape media passing in front of the spin valve sensor, the total input flux is 8πMᵣδW.

Thus, the saturation flux density of a spin valve can be defined as the quantity of the input flux multiplied by the flux injection efficiency, divided by the quantity of the thickness of the free layer of the spin valve sensor multiplied by the width of the magnetic tape media. The free layer is a thin film layer of the spin valve sensor whose magnetization direction is free to rotate in response to an applied field. In mathematical form, this relationship is defined as:

B=(8π*Mᵣ*δ*ζ)/t (1)

where Bₛ is the saturation flux density, Mᵣ is the remnant magnetic moment, δ is the thickness of the magnetic tape media, and ζ is the flux injection efficiency. The flux injection efficiency is the ratio of the flux that actually enters the spin valve to the total amount of flux available leaving the magnetic tape media. In this format, the widths of the magnetic tape media in the numerator and denominator mathematically cancel.

From this relationship, it can be seen that in order to adjust the saturation flux density, and thus, the sensitivity of the spin valve sensor read head, there are two different quantities that may be modified. The first quantity that may be modified is the flux carrying capability of the spin valve sensor. This may entail changing the value of t, the thickness of the free layer, or sensing layer, of the spin valve sensor. Alternatively, this may entail changing the value of the input flux, 8πMᵣδW. The second quantity that may be modified is the flux injection efficiency, ζ. As will be described in greater detail hereafter, there are a number of different ways in which the values for these quantities may be modified through various configurations of the spin valve sensor read head.

The sensitivity of the spin valve read head may be modified in yet another manner. The output of the spin valve read head itself may be modified, i.e. the sensitivity of the spin valve read head may be modified directly. Consider the voltage output of the spin valve read head which is defined as:

dV=(I_{b}R₀(dR/R)dH)/2Hₖ (2)

where dV is the output voltage, I_{b} is the spin valve sensor current, R₀ is the resistance of the spin valve sensor element, dR/R is a change in the resistance of the spin valve sensor element, Hₖ is the antisotropy field value, i.e. the strength of the field required to swing the magnetization direction from an easy-axis to a hard-axis, and dH is the change in the magnetic field. The anisotropy field value is also a measure of the strength of the field required to saturate the spin valve sensor. From this relationship, it can be seen that by increasing the value for Hₖ, the output of the spin valve sensor may be decreased and thus, the sensitivity of the spin valve sensor may be decreased. The present invention provides spin valve sensor configurations which may be used to increase the magnetic field required to saturate the spin valve sensor, as discussed in greater detail hereafter.

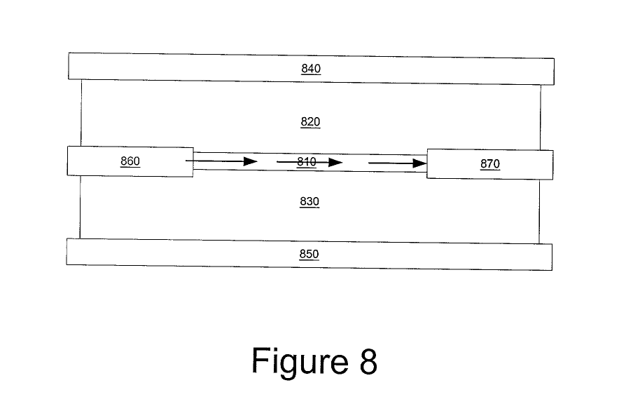

One way in which to increase the value for Hₖ is to increase the stiffness of the spin valve sensor. This is shown in FIG. 7. As shown in FIG. 7, a first curve 710 represents an output from a standard spin valve sensor. The second curve 720 represents the output from a spin valve sensor that has been stiffened in accordance with the present invention, as described hereafter. By stiffening the spin valve sensor, for the same magnetic field, the output of the spin valve sensor is lower. Thus, the amount of the magnetic field needed to saturate the spin valve sensor, i.e. the anisotropy field, is increased. For example, as shown in FIG. 7, the magnetic field required to saturate the standard spin valve sensor is approximately 200 oersteds (Oe), while for the stiffened spin valve sensor, the magnetic field required to saturate the sensor is approximately 400 Oe.

Thus, the present invention, as described hereafter, provides reduced sensitivity spin valve sensor read heads in which one or more of the flux carrying capability of the spin valve sensor, the flux injection efficiency of the spin valve sensor, and the basic magnetic sensitivity of the spin valve sensor are modified from that of a standard spin valve sensor. In this way, a spin valve sensor is provided that has reduced sensitivity such that the readback distortion in the spin valve sensor is reduced and the field required to saturate the spin valve sensor is increased.

### Reducing the Basic Magnetic Sensitivity

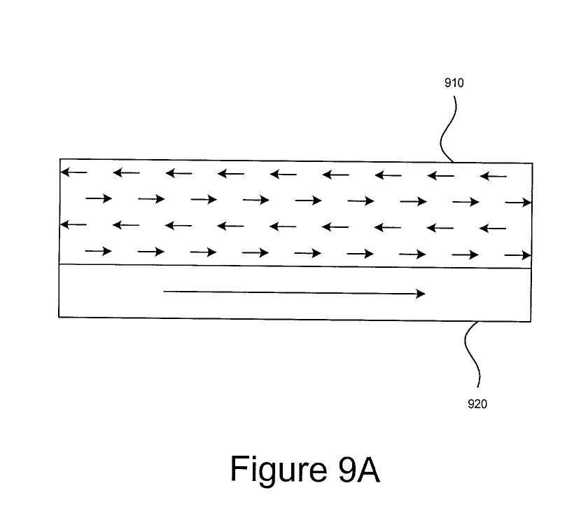

As mentioned above, one way in which to reduce the sensitivity of a conventional spin valve sensor is to magnetically increase the stiffness of the free layer, or sensing layer, of the spin valve sensor. One way to increase the stiffness of the free layer of the spin valve sensor is to increase the effective anisotropy field Hₖ. FIG. 8 is an exemplary block diagram illustrating one embodiment of the present invention in which permanent magnet stabilizing elements are used to increase the stiffness of the free layer of the spin valve sensor.

As shown in FIG. 8, the spin valve sensor 810 is positioned between two films 820 and 830 of insulating material such as alumina, silicon nitride, aluminum nitride, or the like, a top magnetic shield 840 and bottom magnetic shield 850. The insulating films 820, 830 provide insulation and spacing for the spin valve sensor 810 from the top and bottom magnetic shields 840 and 850.

The spin valve sensor 810 is stiffened by permanent magnet stabilizing elements 860 and 870. When magnetized in a longitudinal direction parallel to the free layer easy axis, the permanent magnetic stabilizing elements 860 and 870 apply a longitudinal field to the spin valve free layer. This additional field effectively magnetically “stiffens” the free layer. By stiffening the free layer of the spin valve sensor 810, what is meant is that the amount of magnetic field required to cause the magnetization direction of the free layer of the spin valve sensor to rotate away from the easy-axis is increased and the sensors propensity to saturate is reduced. As a result, the voltage output of the spin valve sensor 810 is reduced.

In a preferred embodiment, the permanent magnet stabilizing elements 860 and 870 are cobalt-platinum/chromium magnets. Cobalt-platinum/chromium magnets are chosen for the preferred embodiment because they have good permanent magnetic properties with in-plane anisotropy to ensure the applied field is in the desired direction.

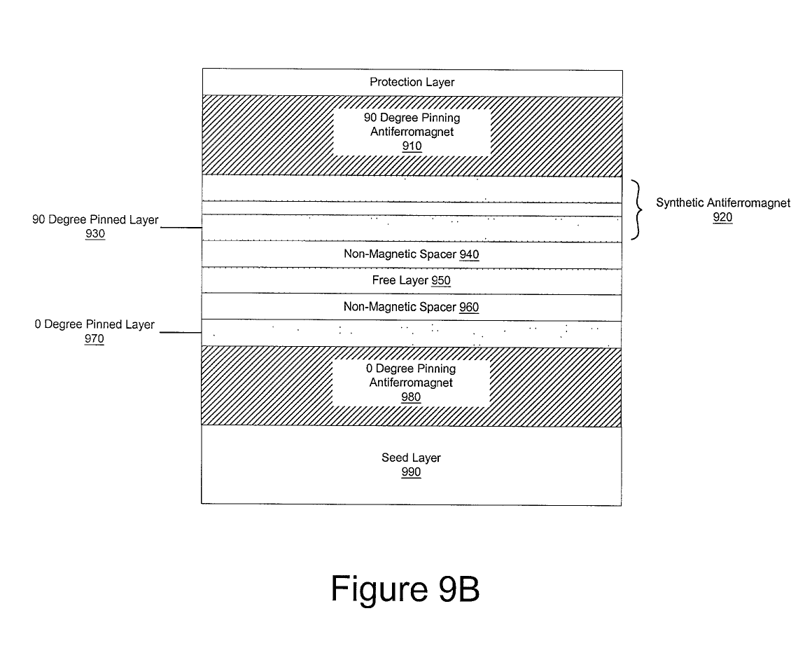

In alternative embodiments, the same effect of stiffening the free layer of the spin valve sensor may be obtained by introducing an antiferromagnet into the spin valve sensor configuration. These alternative embodiments are shown in FIGS. 9. As shown in FIG. 9A, an antiferromagnetic layer 910 is placed in close proximity, such as an overlay, to the free layer of the spin valve sensor 920. The free layer of the spin valve sensor is a ferromagnetic layer and tends to have adjacent flux guide moments line up in the same direction. Thus, the free layer moment of the spin valve sensor 920 is aligned with the magnetic exchange field derived from the antiferromagnet.

The antiferromagnet layer 910 tends to have the moments of adjacent atoms point in opposite directions. Thus, there is no net macroscopic moment in the antiferromagnetic layer 910. It is known that if a ferromagnetic layer is in contact with an antiferromagnetic layer, the moments of atoms in the ferromagnetic layer at the interface with the antiferromagnetic layer will be aligned with the moments of atoms at the corresponding interface of the antiferromagnetic layer. This effect is known as exchange bias or exchange anisotropy.

In view of the above, under appropriate conditions, substantially all of the atomic moments in the free layer of the spin valve sensor 920, i.e. the ferromagnetic layer, can be aligned in a desired direction due to adjacent antiferromagnetic layer 910. Once aligned, a longitudinal exchange induced bias field is introduced into the free layer of the spin valve sensor 920. This longitudinal exchange induced bias field stiffens the free layer of the spin valve sensor 920 in much the same manner as with the magnetic stabilizing elements shown in FIG. 8.

FIG. 9B shows an alternative embodiment in which an additional ferromagnetic layer 970 is used which is pinned with its magnetization parallel to the long axis of the free layer 950 by use of the 0 degree pinning antiferromagnet 980. The additional 0 degree pinning antiferromagnet 980 preferably has a different blocking temperature from the 90 degree pinning antiferromagnet so that the two antiferromagnets can sequentially be annealed with their appropriate orientations.

The additional ferromagnetic layer 970 is spaced away from the free layer by a thin non-magnetic layer 960 (such as copper, gold, an electron reflecting oxide layer, or the like) thickness can be used to control the amount of ferromagnetic exchange between the 0 degree pinned layer 970 and free layer 950. The thickness of this layer, in a preferred embodiment, is approximately between 10 and 25 Angstroms depending on the strength of the effect desired. Thus, the use of the configuration in FIG. 9B provides a “tunable” spin valve sensor.

The use of an antiferromagnetic layer in a magneto-resistive element is generally taught in commonly assigned and copending U.S. patent application Ser. No. ______ (Attorney Docket No. 98-013-TAP) entitled “Dual Element Magnetoresistive Read Head with Integral Element Stabilization,” filed on ______, and which is hereby incorporated by reference. In this application, an antiferromagnetic layer is used in a normal magnetoresistive read head for stabilizing a magnetic domain of the magnetoresistive read head. An undesirable consequence of using the antiferromagnetic layer in this application was the loss of sensitivity of the MR layer. The present invention recognizes the value of loss of sensitivity in this manner when applied to spin valve sensors for magnetic tape read heads, an advantage not recognized in this prior incorporated U.S. patent application Ser. No. ______ (Attorney Docket No. 98-013-TAP).

By using one or more of these approaches to stiffening the free layer of the spin valve sensor, the magnetic field required to saturate the spin valve sensor is increased. Thus, the sensitivity of the spin valve sensor is reduced. As a result, the readback distortion in the sensed magnetic fields is greatly diminished.

### Increasing the Flux Carrying Capacity

In addition to stiffening the spin valve sensor, the flux carrying capacity of the spin valve sensor may be increased in order to reduce the sensitivity of the spin valve sensor. One way to increase the flux carrying capacity is to increase the thickness of the free layer of the spin valve sensor. Currently, the free layer of known spin valve sensors have thicknesses of between 30 and 60A. With the present invention, this thickness is increased to a value above 60A. In a preferred embodiment, the thickness of the free layer of the spin valve sensor is approximately between 90 and 120A.

By increasing the thickness, and thus the cross sectional area, of the free layer of the spin valve sensor, its flux carrying capability is increased and the amount by which the free layer moment rotates for a given flux input is decreased. Thus, the sensitivity of the spin valve sensor is decreased.

Another way in which the flux carrying capability of the spin valve sensor may be increased is to use a dual type spin valve sensor. Dual MR sensors and spin valve sensors are generally known in the art. For example, commonly assigned and copending U.S. patent application Ser. No. ______ (Attorney Docket No. 96-061-TAP) entitled “Method for Reading Both High and Low Density Signals with an MR Head,” filed ______, which is incorporated herein by reference, describes the use of a dual MR sensor read head for reading high and low density signals. In addition, U.S. Pat. No. 5,287,238, issued on Feb. 15, 1994 to Baumgard et al. and entitled “Dual Spin Valve Magnetoresistive sensor,” and which is hereby incorporated by reference, teaches a dual spin valve MR sensor having first, second and third layers of ferromagnetic material separated from each other by layers of non-magnetic metallic material.

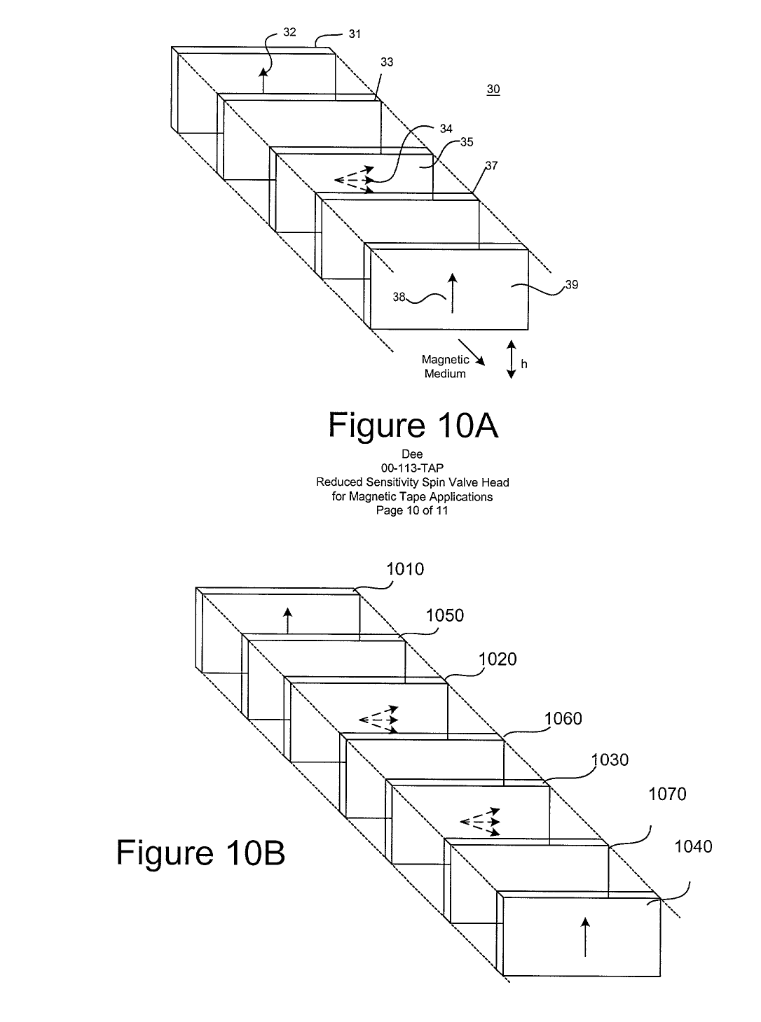

The dual spin valve MR sensor of Baumgard et al. is depicted in FIG. 10A. As shown in FIG. 10A, the dual spin valve MR sensor of Baumgard includes three layers of ferromagnetic material 31, 35 and 39. The dual spin valve MR sensor of Baumgard further includes two layers of non-magnetic material 33 and 37. The magnetizations of the two outer layers 31 and 39 of ferromagnetic material are oriented parallel to each other, i.e., in the same direction, and at an angle of about 90 degrees with respect to the magnetization of the intermediate layer 35 of ferromagnetic material in the absence of an externally applied magnetic field as indicated by arrows 32, 34 and 38, respectively. In addition, the magnetization directions of the first and third outer layers, 31 and 39 of ferromagnetic material are fixed, or pinned, in a preferred orientation as shown by the arrows 32 and 38. Thus, while the magnetization directions of the outer ferromagnetic layers 31, 39 remain fixed, the magnetization in the intermediate layer 35 of ferromagnetic material is free to rotate its direction in response to an externally applied magnetic field (such as magnetic field H), as shown by the dashed arrows 34 on layer 35. The dual spin valve MR sensor of Baumgard provides a large MR response at low applied magnetic fields. This is contrary to the desired result of the present invention.

FIG. 10B illustrates a dual spin valve MR sensor according to one embodiment of the present invention. As shown in FIG. 10B, the configuration is similar to that of the Baumgard dual spin valve MR sensor with the exception that four ferromagnetic material layers 1010-1040 are provided and spaced from one another by three non-magnetic spacers 1050-1070. The two outer ferromagnetic layers 1010 and 1040 are pinned, i.e. have fixed magnetization directions. The two inner ferromagnetic layers 1020 and 1030 are free layers whose magnetization directions are free to rotate based on an applied magnetic field. By providing two free layers, the present invention allows the magnetic flux to be spread across the two free layers thereby reducing the magnetic flux fed to each free layer to half. By reducing the magnetic flux in this manner, the saturation propensity is reduced (see equation (1)). In this case, the high output afforded by the spin valve sensor is retained as the electron scattering mechanism responsible for the GMR effect at layer interfaces is preserved without any shunting by thicker layers.

### Reducing the Flux Injection Efficiency

As another mechanism for reducing the sensitivity of the spin valve sensor, the flux injection efficiency, ζ, of the spin valve sensor head may be reduced. There are a number of ways in which this may be accomplished.

One way in which to reduce the flux injection efficiency is to reduce the space between the spin valve sensor and the magnetic shields. This bleeds the flux to the shields quicker and reduces the flux injection efficiency. In order to reduce the space between the spin valve sensor and the magnetic shields, the thickness of the insulation layers between the spin valve sensor and the magnetic shields may be reduced.

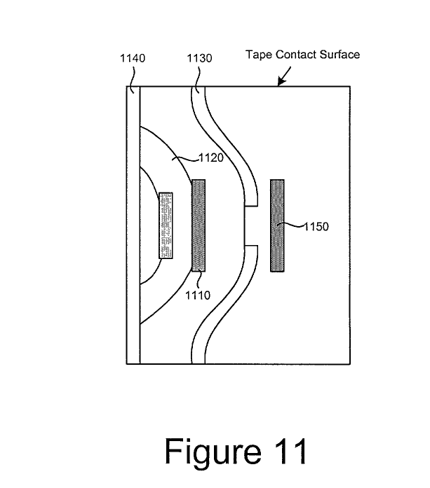

Yet another way in which the flux injection efficiency may be reduced is to use an inefficient yoke structure that feeds less flux into the spin valve sensor. The efficiency of flux transfer from the magnetic tape media through the flux guides can be adjusted by altering the spacing between the flux guide and the spin valve element or by altering the magnetic properties of the flux guides. Such structures are generally known, see Koel et al. “Thin film magnetic head for reading and writing information,” U.S. Pat. No. 4,150,408, which is hereby incorporated by reference, but in practice show relatively low output signals due to this inefficiency. An embodiment of the present invention similar to the structure of Koel et al. is shown in FIG. 11.

As shown in FIG. 11, the spin valve sensor read head is essentially the same as the prior art spin valve read head depicted in FIG. 2B with the exception that a second spin valve element 1110 is provided on the planars 1120. In this way, the flux generated by the top flux guide 1130 and the bottom flux guide 1140 is shared between both the first spin valve element 1150 and the second spin valve element 1160. As a result the amount of flux handled by each spin valve element is reduced and thus, the flux injection efficiency of each spin valve element is reduced. This causes the saturation propensity to be reduced.

Each of these various mechanisms can be used alone or in conjunction with other ones of these mechanisms to reduce the sensitivity of the spin valve sensor read head. As mentioned above, the sensitivity is reduced in order to reduce the readback distortion in the signals generated by the spin valve sensor. However, the sensitivity of the spin valve sensor is not be reduced so much as to eliminate the benefits provided by spin valve sensors. Rather, a compromise of benefits is intended by the present invention.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An apparatus for reading data, comprising:
a magnetic tape media contact surface configured to contact a magnetic tape media; and
a reduced sensitivity spin valve sensor, wherein the reduced sensitivity spin valve sensor senses an applied magnetic field from the magnetic tape media when the magnetic tape media passes by the reduced sensitivity spin valve sensor, and wherein the reduced sensitivity spin valve sensor has a sensitivity less than magnetic disk head spin valve sensors

2. The apparatus of claim 1, wherein the reduced sensitivity spin valve sensor has a sensitivity that is reduced by one of reducing a basic magnetic sensitivity of the spin valve sensor, increasing the flux carrying capacity of the spin valve sensor, and reducing a flux injection efficiency of the spin valve sensor.

3. The apparatus of claim 1, wherein the reduced sensitivity spin valve sensor has a sensitivity that is reduced from a sensitivity of the magnetic disk head spin valve sensor by increasing a thickness of a free layer of a magnetic disk head spin valve sensor.

4. The apparatus of claim 1, wherein the reduced sensitivity spin valve sensor has a sensitivity that is reduced from a sensitivity of the magnetic disk head spin valve sensor by increasing an effective anisotropy field of a free layer in a magnetic disk head spin valve sensor.

5. The apparatus of claim 4, wherein the effective anisotropy field of the magnetic disk head spin valve sensor is increased by increasing a stiffness of a free layer of the magnetic disk head spin valve sensor.

6. The apparatus of claim 5, wherein the stiffness of the free layer is increased by using at least one permanent magnet stabilizing element to impart a stiffening magnetic field to the free layer.

7. The apparatus of claim 6, wherein the at least one permanent magnet stabilizing element is a cobalt-platinum-chromium magnet.

8. The apparatus of claim 5, wherein the stiffness of the free layer is increased by using an antiferromagnet to impart a stiffening magnetic field to the free layer.

9. The apparatus of claim 5, wherein the stiffness of the free layer is increased by using both an antiferromagnet and at least one permanent magnet stabilizing element to impart a stiffening exchange magnetic field to the free layer.

10. The apparatus of claim 3, wherein the thickness of the free layer is increased above 60A.

11. The apparatus of claim 3, wherein the thickness of the free layer is increased to between 90A and 120A, inclusively.

12. The apparatus of claim 1, wherein the reduced sensitivity spin valve sensor has a sensitivity that is reduced from a sensitivity of the magnetic disk head spin valve sensor by using a dual type spin valve sensor in which an input flux is distributed across two free layers.

13. The apparatus of claim 12, wherein the dual type spin valve sensor has four ferromagnetic material layers spaced from one another by three non-magnetic spacers.

14. The apparatus of claim 13, wherein an outer two of the four ferromagnetic material layers have fixed magnetization directions, and wherein an inner two of the four ferromagnetic material layers are free layers.

15. The apparatus of claim 1, wherein the reduced sensitivity spin valve sensor has a sensitivity that is reduced from a sensitivity of the magnetic disk head spin valve sensor by reducing the space between the spin valve sensor and a magnetic shield to thereby, reduce a flux injection efficiency of the magnetic disk head spin valve sensor.

16. The apparatus of claim 1, wherein the reduced sensitivity spin valve sensor has a sensitivity that is reduced from a sensitivity of the magnetic disk head spin valve sensor by providing two spin valve sensor elements in a yoke structure of the head to thereby, distribute an input flux across the two spin valve sensor elements.

17. A method of using a spin valve sensor to read data from a magnetic tape media, comprising:
passing a magnetic tape media before a magnetic tape media head; and
sensing an applied magnetic field from the magnetic tape media using a spin valve sensor, the spin valve sensor having a reduced sensitivity for use with magnetic tape media.

18. The method of claim 17, wherein the spin valve sensor has a sensitivity that is reduced by one of reducing a basic magnetic sensitivity of the spin valve sensor, increasing a flux carrying capacity of the spin valve sensor, and reducing a flux injection efficiency of the spin valve sensor.

19. The method of claim 17, wherein the spin valve sensor has a sensitivity that is reduced by increasing a thickness of a free layer of the spin valve sensor.

20. The method of claim 17, wherein the spin valve sensor has a sensitivity that is reduced by increasing an effective anisotropy field.

21. The method of claim 20, wherein the anisotropy field is increased by increasing a stiffness of a free layer of the spin valve sensor.

22. The method of claim 21, wherein the stiffness of the free layer is increased by using at least one permanent magnet stabilizing element to impart a stiffening magnetic field to the free layer.

23. The method of claim 22, wherein the at least one permanent magnet stabilizing element is a cobalt-platinum-chromium magnet.

24. The method of claim 21, wherein the stiffness of the free layer is increased by using an antiferromagnet to impart a stiffening magnetic field to the free layer.

25. The method of claim 21, wherein the stiffness of the free layer is increased by using both an antiferromagnet and at least one permanent magnet stabilizing element to impart a stiffening exchange magnetic field to the free layer.

26. The method of claim 19, wherein the thickness of the free layer is increased above 60A.

27. The method of claim 19, wherein the thickness of the free layer is increased to between 90A and 120A, inclusively.

28. The method of claim 17, wherein the spin valve sensor has a sensitivity that is reduced by using a dual type spin valve sensor in which an input flux is distributed across two free layers.

29. The method of claim 28, wherein the dual type spin valve sensor has four ferromagnetic material layers spaced from one another by three non-magnetic spacers.

30. The method of claim 29, wherein an outer two of the four ferromagnetic material layers have fixed magnetization directions, and wherein an inner two of the four ferromagnetic material layers are free layers.

31. The method of claim 17, wherein the spin valve sensor has a sensitivity that is reduced by reducing a space between the spin valve sensor and a magnetic shield to thereby, reduce a flux injection efficiency of the spin valve sensor.

32. The method of claim 17, wherein the spin valve sensor has a sensitivity that is reduced by providing two spin valve sensor elements in a yoke structure of the head to thereby, distribute an input flux across the two spin valve sensor elements.
